(19) United States
(12) Patent Application Publication
(10) Pub. No.: US 2006/0095351 A1
(43) Pub. Date: May 4, 2006

(54) Combining a retirement income management account with a retirement income plan

(76) Inventors: Shari Gershenfeld, Brookline, MA (US); Paul Hoxie, Newton, MA (US); Ed Cady, North Reading, MA (US); Charles Berman, Concord, MA (US); Joe Benersani, Boston, MA (US)

Correspondence Address: PROSKAUER ROSE LLP, ONE INTERNATIONAL PLACE 14TH FL, BOSTON, MA, 02110, US

(21) Appl. No.: 10/977,353

(22) Filed: Oct. 29, 2004

(51) Int. Cl. G06Q 40/00

(52) U.S. Cl. 705/35

(57) ABSTRACT

Described are methods and apparatus, including computer program products, for combining a retirement income management account with a retirement income plan. A first set of data is obtained from a retirement income plan associated with a user. The first set of data includes a projected withdrawal from a retirement asset account. A second set of data is obtained from a retirement income management account associated with the user. An actual withdrawal from the retirement asset account is determined based on the second set of data. A display is generated showing the projected withdrawal compared to the actual withdrawal.

### RELATED APPLICATIONS

The present invention relates to computer-based methods and apparatuses, including computer program products, for combining a retirement income management account with a retirement income plan.

### FIELD OF THE INVENTION

With the social security trust fund shrinking and the “baby boomer” generation approaching retirement, there is increased interest in retirement planning. There are several different approaches, many proprietary, for determining how much money people should have when they reach retirement age. For example, a search for retirement planning tools on the Fidelity Investments web site (www.fidelity.com) reveals a quick check tool to determine if a person is on track to achieve his savings goals for retirement, an income estimator to estimate how much pre-tax income a person may be able to withdraw from his Fidelity accounts during retirement, and a Retirement Income Planner (RIP) tool to create a detailed income plan that includes all of a person's assets, to help achieve his desired retirement lifestyle. Once a retiree reaches retirement, her actual expenses change as events happen in her retirement, resulting in expenses that may or may not be as she planned.

### SUMMARY OF THE INVENTION

The invention features computer-based methods and apparatuses, including computer program products, for combining a retirement income management account with a retirement income plan. In one aspect, there is a computerized method for combining a retirement income management account with a retirement income plan. The method includes obtaining a first set of data from a retirement income plan associated with a user, where the first set of data includes a projected withdrawal from a retirement asset account, and obtaining a second set of data from a retirement income management account associated with the user. The method also includes determining an actual withdrawal from the retirement asset account based on the second set of data and generating a display showing the projected withdrawal compared to the actual withdrawal.

In another aspect, there is a computerized method for combining a retirement income management account with a retirement income plan. The method includes obtaining a first set of data, represented using XML, from a retirement income plan associated with a user, where the first set of data including a projected withdrawal from a retirement asset account. The method also includes obtaining a second set of data from a retirement income management account associated with the user and determining an actual withdrawal from the retirement asset account based on the second set of data. The method also includes determining whether a predefined alert condition has been met using the first set of data or the second set of data and generating a display showing the projected withdrawal compared to the actual withdrawal.

In another aspect, there is a computer program product, tangibly embodied in an information carrier, for combining a retirement income management account with a retirement income plan. The computer program product includes instructions being operable to cause data processing apparatus to obtain a first set of data from a retirement income plan associated with a user, where the first set of data including a projected withdrawal from a retirement asset account and to obtain a second set of data from a retirement income management account associated with the user. The computer program product also includes instructions being operable to cause data processing apparatus to determine an actual withdrawal from the retirement asset account based on the second set of data and generate a display showing the projected withdrawal compared to the actual withdrawal.

In another aspect, there is a system for combining a retirement income management account with a retirement income plan. The system includes a financial planning platform, a cash management and brokerage platform, and a consumer interface layer. The financial planning platform is an element of the system that enables a user to create a retirement income plan. The cash management and brokerage platform is an element of the system that enables the user to manage retirement income and retirement asset accounts. The cash management and brokerage platform is in communication with the financial planning platform using an XML interface. The consumer interface layer is an element of the system that enables the user to access the retirement income plan and the retirement income and retirement asset accounts. The consumer interface layer is in communication with the financial planning platform and the cash management and brokerage platform.

In another aspect, there is a system for combining a retirement income management account with a retirement income plan. The system includes a first, second, and thirds means. The first means obtains from a retirement income plan a projected withdrawal from a retirement asset account. The second means obtains from a retirement income management account an actual withdrawal from the retirement asset account. The third means generates a display showing the projected withdrawal compared to the actual withdrawal.

In other examples, any of the aspects above can include one or more of the following features. A variance between the actual withdrawal and the projected withdrawal can be calculated and the display can be generated showing the variance. The variance can be displayed as a percentage. The projected withdrawal and the actual withdrawal can be represented as percentages. The projected withdrawal and the actual withdrawal can be represented as dollar amounts. The projected withdrawal and the actual withdrawal can be represented over a period of one month. The projected withdrawal and the actual withdrawal can be represented using an average over twelve months.

The first set of data can include a target asset allocation for the retirement asset account and the second set of data can include an actual asset allocation for the retirement asset account. Using these two sets of data, a variance between the actual asset allocation and the target asset allocation can be calculated and the display can be generated showing the variance. A hyperlink can be associated with the variance, where the user is enabled to navigate to the retirement asset account using the hyperlink. An electronic alert message can be transmitted when the variance exceeds a predefined threshold. A user interface can be provided to enable the user to access the retirement income plan and the retirement income management account. An electronic alert message can be transmitted when the user has not accessed the retirement income plan for a period greater than a predefined threshold.

An alert message can be transmitted to the user when a predetermined condition is met. A user interface can be provided that enables a user to select one or more alert messages. The alert messages can include a social security deposit confirmed message, a social security deposit not received message, a pension deposit confirmed message, an annuity deposit confirmed message, a spending money low message, an insufficient funds for transfer message, an estimated quarterly tax payment due message, a minimum required distribution (MRD) deadline upcoming message, a current asset allocation off target message or a plan not visited recently message. The user interface can enable the user to select a channel of delivery for at least one alert message. The channel of delivery can include an electronic message, a message to a pager, or a message to a phone.

The retirement income plan can be updated based on the second set of data. A projected period of time remaining until the retirement asset account is depleted can be calculated based on the second set of data. The retirement asset account can include a 401K account. The retirement asset account can include an individual retirement account (IRA) account. The retirement asset account can include a portion of funds being held as equities. The first set of data can be represented using XML.

Implementations can realize one or more of the following advantages. The techniques described herein provide a simple way to compare one or more elements of a retirement plan with actual retirement income and asset management. This enables an automated feedback as to how well the actual management of the assets and income follows the plan. The plan can be modified according to the actual spending behaviors. The reporting can be centralized for all retirement accounts. A single service provider can provide a single point for a retiree to access all of her retirement information, including employer retirement plans, other investment accounts, and retirement income sources. The account also provides administrative simplicity for the retiree, by enabling the retiree to sign up for alerts that remind her about important tax payments, notify her when income sources are received into the account, and caution her when certain aspects of financial behavior are deviating from components of the plan. One implementation of the invention provides at least one of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram of a computer system used for combining a retirement income management account with a retirement income plan.

FIG. 2A is a process diagram showing a method for combining a retirement income management account with a retirement income plan.

FIGS. 2B-2D are screen shots showing a set of data obtained from a retirement income plan.

FIGS. 3A-3I are screen shots of displays used for combining a retirement income management account with a retirement income plan.

FIG. 4 is a block diagram of a computer architecture used for combining a retirement income management account with a retirement income plan.

FIGS. 5A-5D are screen shots of displays used for selecting alerts.

FIG. 6 is a block diagram of another computer system used for combining a retirement income management account with a retirement income plan.

### DETAILED DESCRIPTION

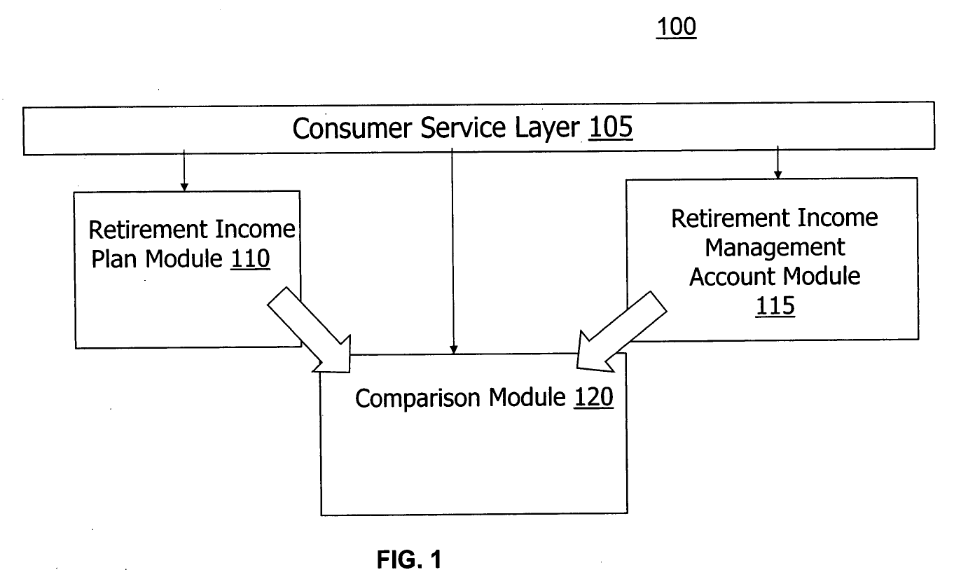

FIG. 1 illustrates a system 100 for combining a retirement income management account with a retirement income plan. The system 100 includes a consumer service layer 105, a retirement income plan module 110, a retirement income management module 115, and a comparison module 120. The consumer service layer 105 serves as an interface for a user. The consumer service layer 105 enables the user to access the retirement income plan module 110 to enter and modified her retirement income plan. A retirement income plan represents a long-term financial strategy to assure that the retiree has income to meet her needs throughout her retirement. The consumer service layer 105 also enables the user to access the retirement income management account 115 to view deposits to and withdrawals from her retirement income management account. A retirement income management account serves as a centralized retirement account to track the financial transactions of the retiree. The retiree can establish the account to receive income from retirement sources, such as Social Security, a pension plan, an annuity payment, withdrawals from retirement asset accounts, etc. The funds the retiree uses for her everyday expenses can be withdrawn from the retirement income management account so that the retiree's cash flow can be monitored. The retirement income management account 115 monitors transactions on a daily, monthly, and/or quarterly basis.

The consumer layer 105 also enables the user to access the comparison module 120. In general, the comparison module 120 compares the user's retirement income plan with the user's actual spending from the retirement income management account. This enables the user to see how her spending compares to her plan and make adjustments accordingly. The comparison module 120 monitors data from the modules 110 and 115, analyzes the data for variances between the plan and the actual spending, and generates alerts to the users when certain conditions are met. The comparison module 120 generates a user interface that enables the user to see both her plan and her spending compared to each other.

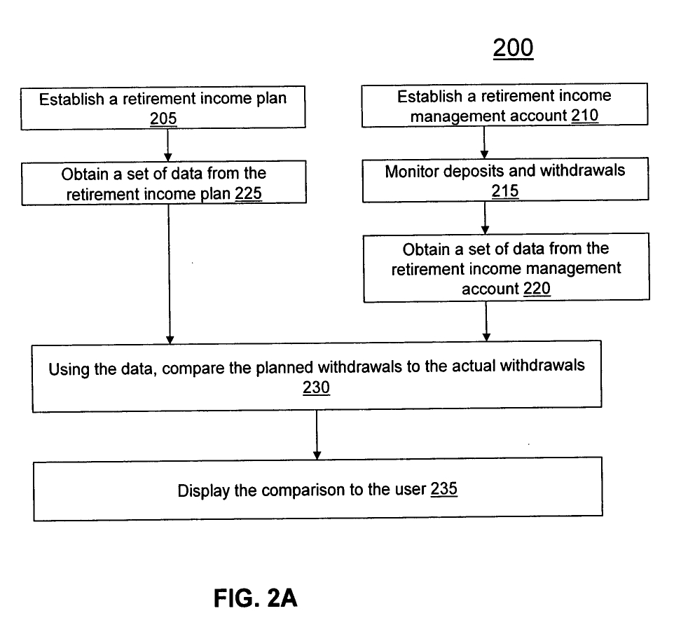

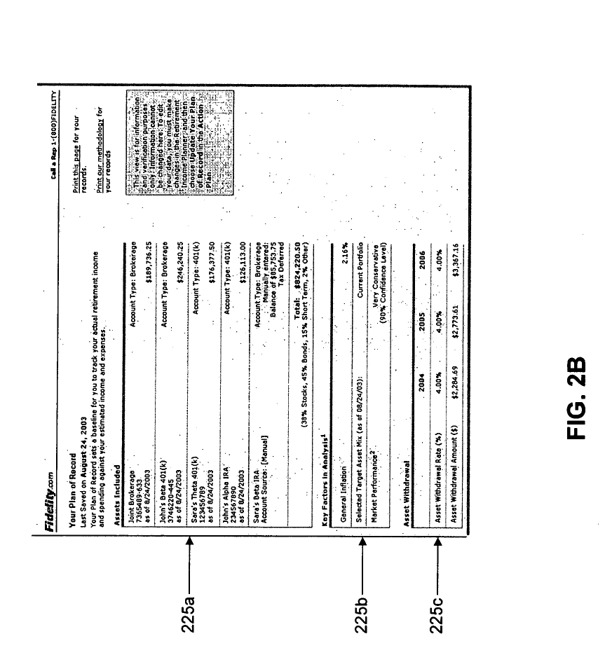

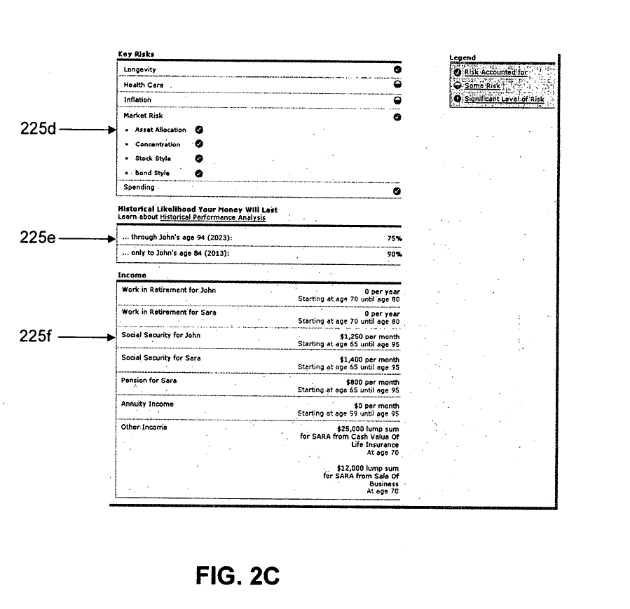

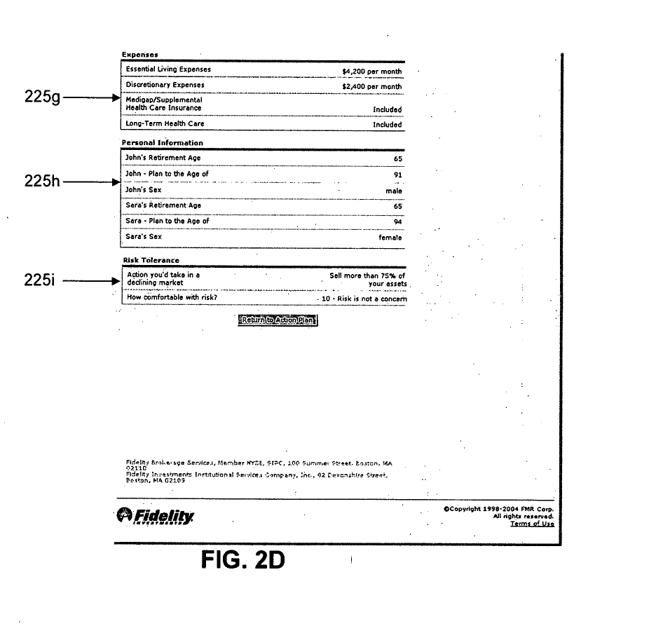

FIG. 2A illustrates a process 200 for combining a retirement income management account with a retirement income plan. A user establishes a retirement income plan (205). For example, the user can use the Retirement Income Planner (RIP) tool on the Fidelity Web site to establish a plan for using one or more retirement accounts to generate retirement income throughout the retirement years of the retiree. The retirement plan typically includes a certain asset allocation (e.g., securities funds, bond funds, money market funds, mutual funds of different types (e.g., growth, income, balanced, small cap, large cap, etc.)) for the one or more retirement accounts so that a projected income stream can be maintained throughout a projected lifetime of the retiree in retirement.

The user also establishes a retirement income management account (210). Using electronic fund transfers (e.g., automatic deposit), the retiree can arrange to have retirement payments (e.g., Social Security, payments from a pension plan, payments from an annuity, etc.) automatically deposited into the established retirement income management account. Similarly, withdrawals can be made from other retirement asset accounts (e.g., IRAs, 401K, etc.) and electronically transferred into the established retirement income management account to supplement the retirement payments previously described. The retiree then uses the established retirement income management account to pay for expenses. This can be done, for example, by using a credit card and/or check book that deducts transactions directly from the established retirement income management account. Alternatively, or in addition, the established retirement income management account can transfer funds to an established bank account of the retiree. This setup enables an automated monitoring of deposits to, withdrawals from, and balances of the established retirement income management account (215).

The system 100 (e.g., the comparison module 120) obtains a set of data from the retirement income management account (220). For example, this data can include an actual allocation for the retiree's retirement asset accounts. This data can also include the total monthly expenses that were paid from the retirement income management account. This data can also include the amount of retirement income (e.g., Social Security, pension, annuity) deposited into the retirement income management account for a month. If the expenses exceed the deposits, this data can also include the amount of money that was withdrawn from the retiree's retirement asset accounts to make up for the gap. If this amount is not included in the data obtained (220), the system 100 can calculate this amount by subtracting the monthly expenses by the monthly deposits. Although the time period is described as a month, other periods of time (e.g., weekly, quarterly, annually, etc.) can be used.

The system 100 (e.g., the comparison module 120) also obtains a set of data from the retirement income plan (225). For example, this data can include the projected monthly withdrawals from the retiree's retirement asset accounts. This data can also include a target allocation for the retiree's retirement asset accounts. Using the data obtained from the retirement income management account (220) and the data obtained from the retirement income plan (225), the system 100 compares the planned withdrawals to the actual withdrawals (230). The system 100 generates a display and displays the comparison to the user (235).

FIGS. 2B-2D illustrate an example of a set of data, also referred to as a plan of record, obtained from a retirement income plan. Area 225a shows information captured about the retirement asset accounts. Area 225b shows information captured about the assumptions used in the retirement income plan. Area 225c shows information captured about the planned withdrawal rates and amounts used in the retirement income plan. Area 225d shows information captured about the key risks used in the retirement income plan. Area 225e shows information captured about the mortality tables and the confidence levels used in the retirement income plan. Area 225f shows information captured about the planned sources and amounts of retirement income used in the retirement income plan. Area 225f shows information captured about the planned sources and amounts of retirement income used in the retirement income plan. Area 225g shows information captured about the planned expenses used in the retirement income plan. Area 225h shows personal information captured about the retirees used in the retirement income plan. Area 225i shows information captured about the risk tolerance used in the retirement income plan

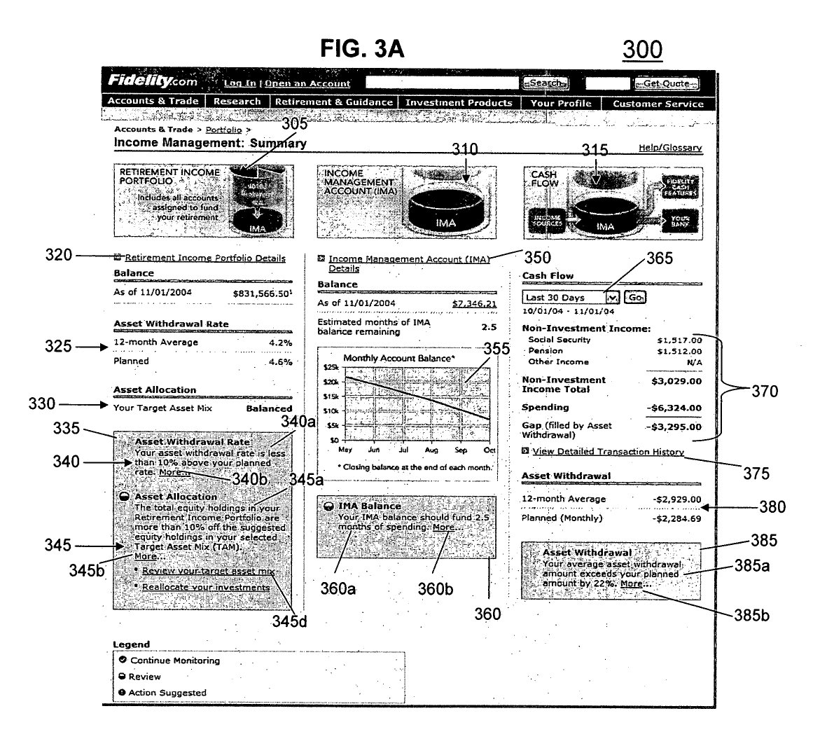

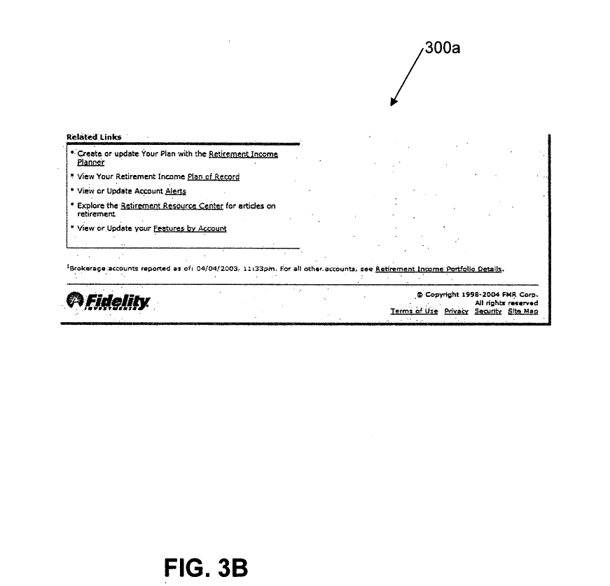

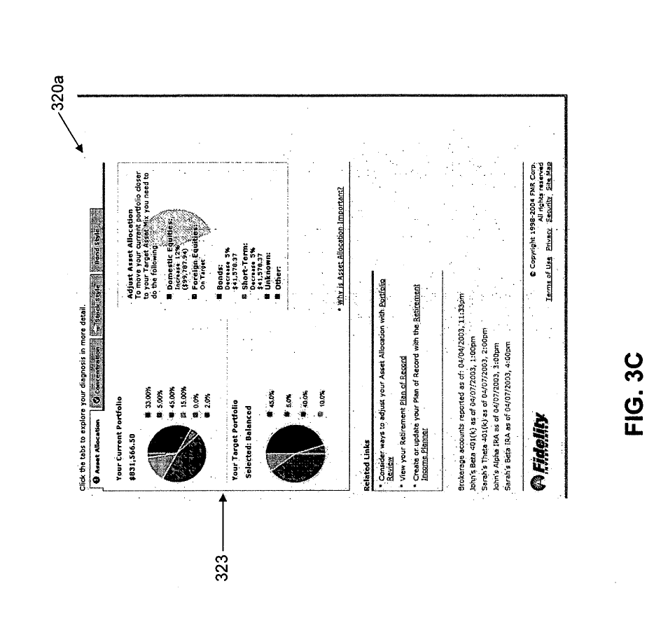

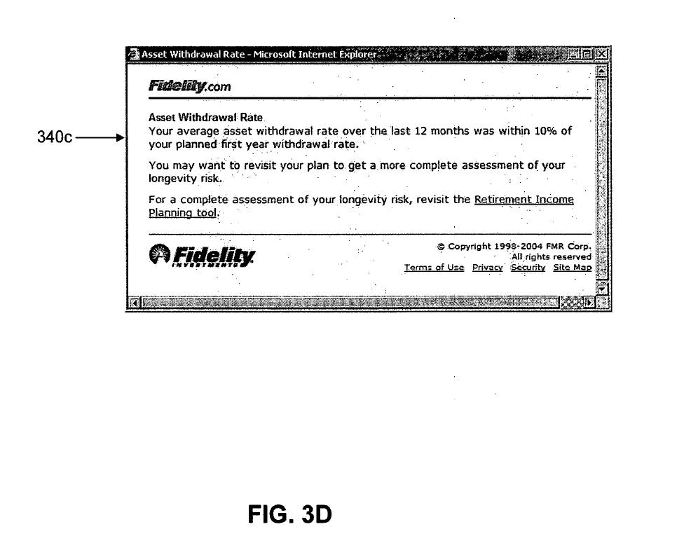

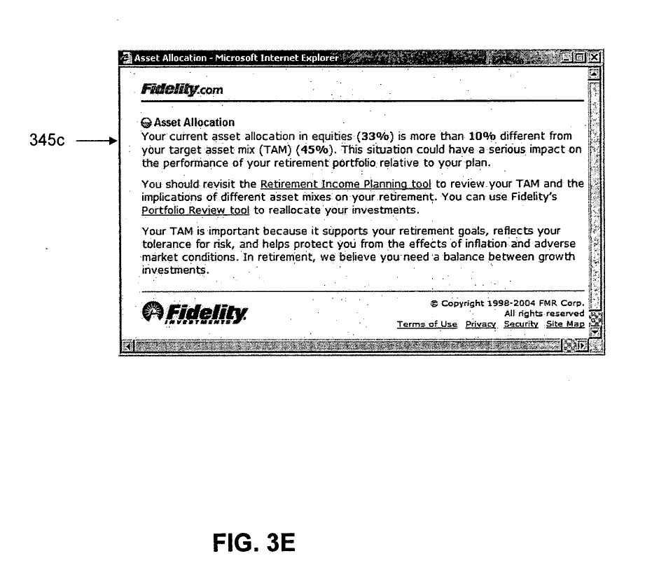

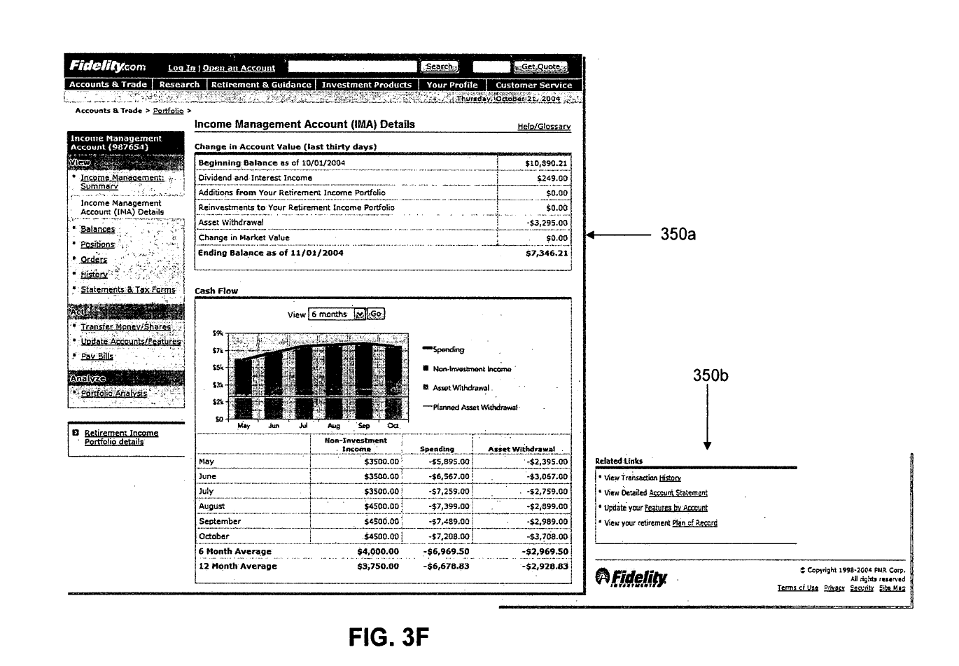

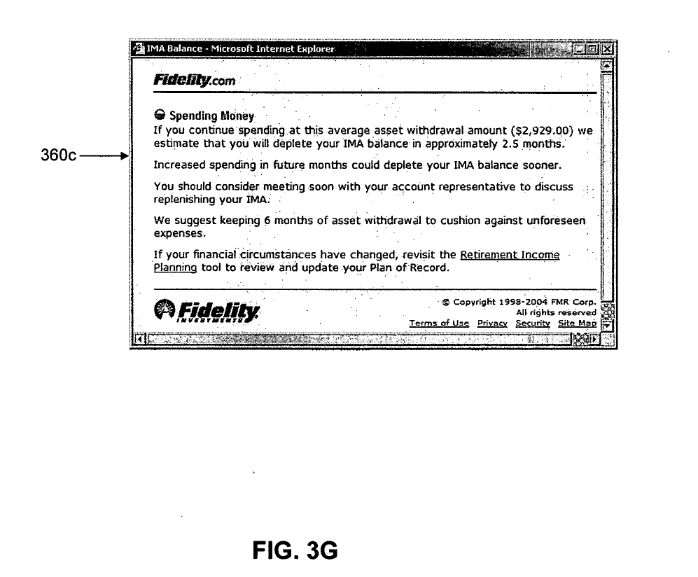

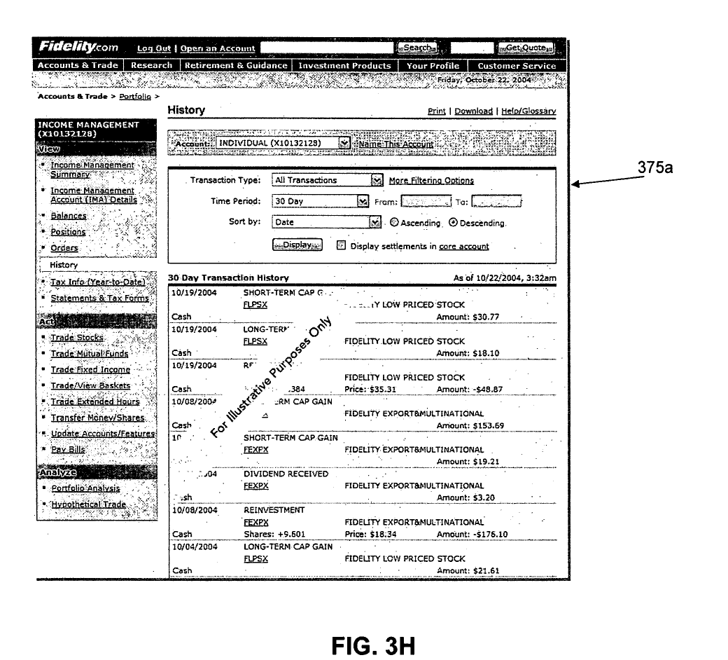

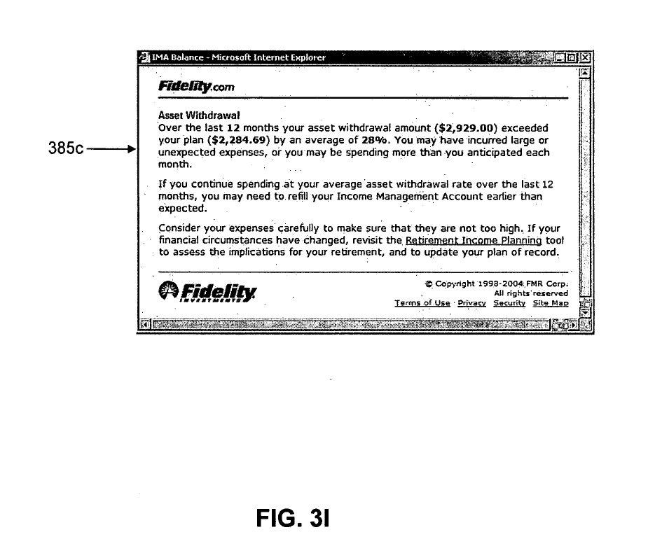

FIG. 3A illustrates a display 300 that includes a comparison represented in various formats. The display 300 is a user interface, enabling the user to change the time period and navigate to other detailed data and retirement tools. The display 300 includes three columns 305, 310, and 315. The first column 305 represents a summary of the retirement income portfolio, which is the aggregation of the user's retirement asset accounts (e.g., 401K, IRA, etc). The retirement asset accounts can include all of the retirement asset accounts that are managed by the service provider providing the display 300. For example, if Fidelity Investments of Boston, Mass. provides the display 300, then the retirement asset accounts include all of the user's retirement asset accounts that are managed by Fidelity Investments. The data in the display 300, however, is not limited to those accounts. The system 100 can also obtain data for other retirement asset accounts of the user and add the data into the display 300. For example, Fidelity has a tool Full ViewSM that aggregates Fidelity and non-Fidelity accounts. Such a tool can be used to obtain data for all of a user's retirement asset accounts.

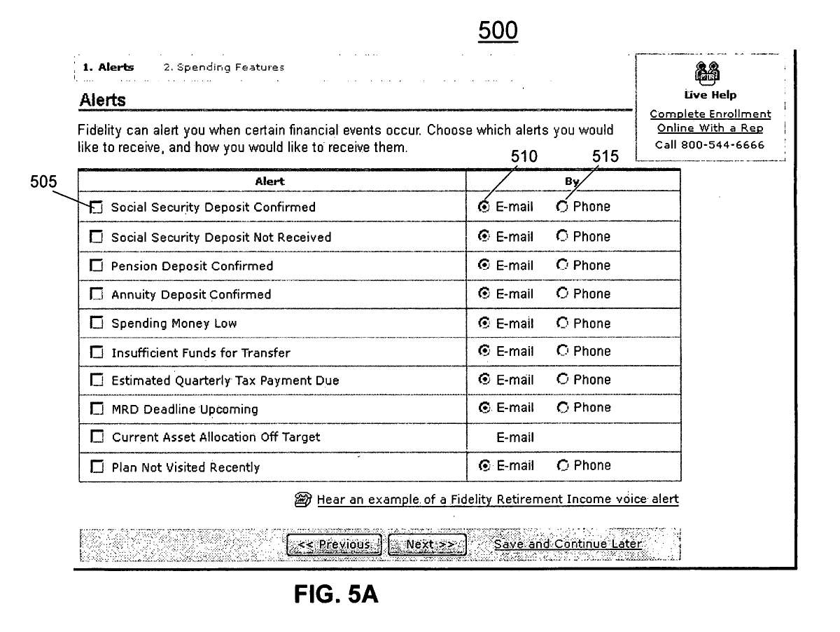

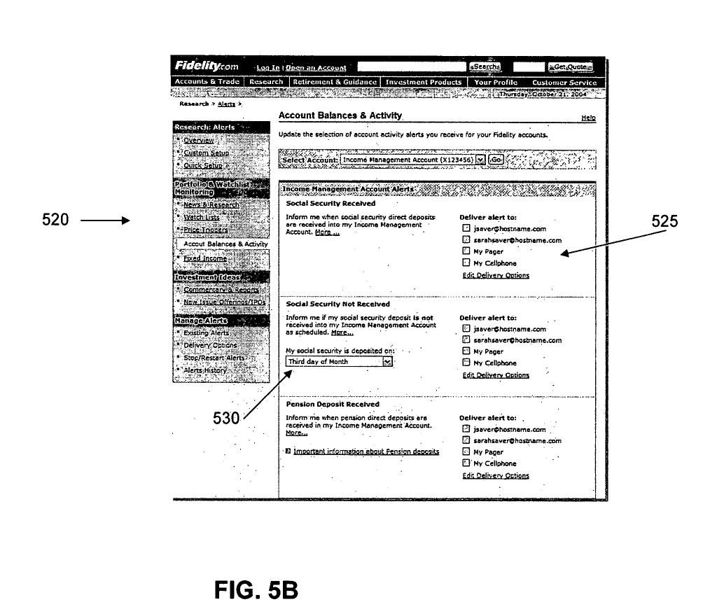

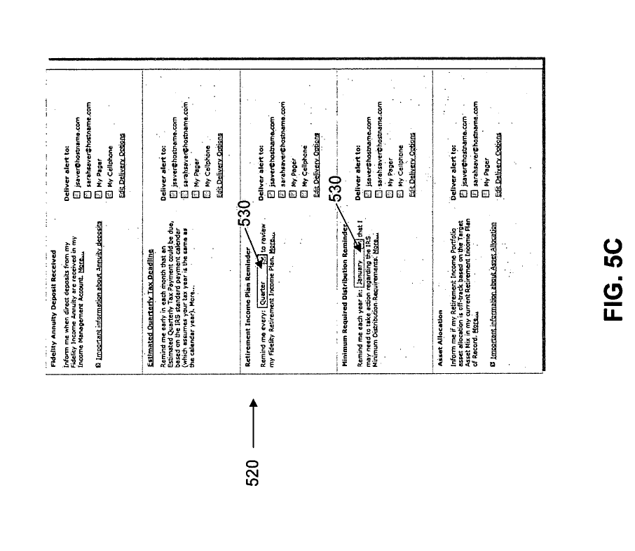

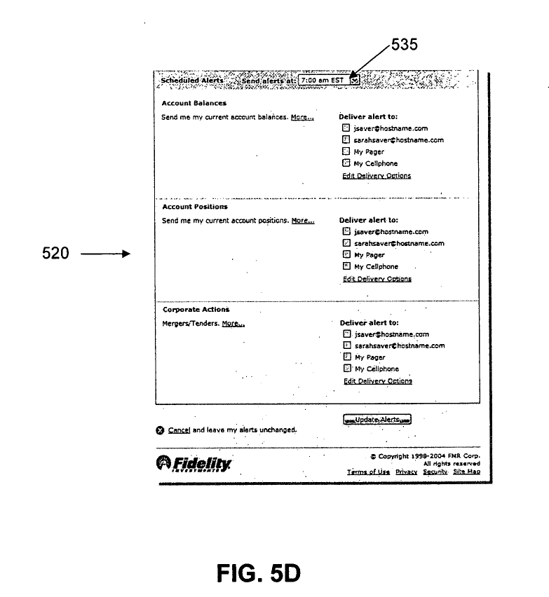

FIG. 3B illustrates a pop-up box 300a that can be displayed with the display 300. The pop-up enables the user to navigate to additional tools that do not have hyperlinks within the display 300. For example, the user can navigate to the plan of record used in generating the display 300. An example of a plan of record is illustrated in FIGS. 2B-2D. The user can also navigate to an alerts tool, described in more detail below with FIGS. 5A-5D.

Referring back to the display 300 in FIG. 3, the first column 305 includes a hyperlink 320 to enable the user to obtain more detailed information about the retirement income portfolio. FIG. 3C illustrates a display 320a that the system generates when the user selects hyperlink 320. The information in display 320a includes a breakdown of total assets in the Retirement Income Portfolio by account and by asset class. The display 320a also provides a comparison area 323 that displays the actual asset class breakdown of the retirement asset accounts to the Target Asset Mix (TAM) selected in the income plan.

Referring back to the display 300 in FIG. 3, below the current balance of the retirement income portfolio, there is a comparison area 325 that shows a comparison between the actual average monthly withdrawal rate (i.e., the 4.2%) from the retirement asset accounts and the planned withdrawal rate (i.e., the 4.0%) from the retirement asset accounts. Here the user quickly views how her actual performance is doing compared to her plan and how large the discrepancy is. A 12-month average is used to smooth any monthly spikes that may be due to quarterly payments, such as tax payments or large one-time expenditures. Below the comparison area 325, there is an asset allocation area 330 that provides a qualitative description (e.g., “balanced”) of the target asset allocation of the retirement income portfolio.

Below the allocation area 330 is a messaging box 335. The messaging box 335 includes a comparison summary of the withdrawal rate 340 and a comparison summary of the asset allocation 345. The comparison summary of the withdrawal rate 340 includes a textual summary 340a that indicates to the user the extent to which the actual withdrawal rate is within a reasonable range of the planned rate. The withdrawal rate messaging that appears can be customized based on the number of months of data that are available for that customer and the extent to which the actual rate is off from the planned rate. For example, no asset withdrawal information is provided prior to 30 days of account activity availability. From 2 to 6 months, the system calculates the actual asset withdrawal rate, but does not provide comparisons to plan. From 7 months forward, comparisons to plan are made and two different messages are shown, depending on whether the actual rate is more or less than 10% from the planned rate.

The comparison summary of the withdrawal rate 340 also includes a hyperlink 340b that provides a more detailed message relating to the asset withdrawal rate. FIG. 3D illustrates a pop-up box 340c that the system generates when the user selects the hyperlink 340b. This more detailed message in the pop-up box 340c restates whether the customer's actual average withdrawal rate over the past “x” months is more or less than 10% of the planned first year withdrawal rate and suggests actions that the user may want to take, depending on the particular situation.

Referring back to the display 300 in FIG. 3, the comparison summary of the asset allocation 345 includes a textual summary 345a that states to the user the extent to which the actual asset allocation is different from the target asset allocation in the income plan based on the equity portion of the portfolio. The comparison summary of the asset allocation 345 also includes a hyperlink 345b that enables the user to access more details about the comparison of the actual asset allocation to the planned asset allocation. When the user clicks on “More . . . ”, she receives a message that further reinforces the comparison between the actual asset allocation and the Target Asset Mix and suggests actions that the user may want to take. FIG. 3E illustrates an example of a pop-up box 345c that the system generates when the user selects the hyperlink 345b.

Referring back to the display 300 in FIG. 3, the comparison summary of the asset allocation 345 also includes another hyperlink 345d that enables the user to access more details about her target asset allocation. When the user selects the hyperlink 345d (e.g., uses an input device, such as a mouse, to move the cursor over the hyperlink and then presses another button (e.g., a left side button on the mouse)), the system 100 navigates the display to the user's retirement income plan. From this screen, the user can click through to a Portfolio Review tool which provides more specific guidance on trades that could be made to bring the portfolio in closer alignment with the Target Asset Mix.

The second column 310 represents a summary of the retirement income management account, which receives funds from the user's retirement income sources (e.g., Social Security, pensions, withdrawals from her retirement asset accounts, etc.). The second column 310 includes a hyperlink 350 to enable the user to obtain more detailed information about the retirement income management account. FIG. 3F illustrates and example of an IMA details page 350a to which the user navigates if she selects the hyperlink 350. The IMA Details page 350a shows a summary of the account's change in asset value for the past thirty days and a graph of monthly historical data (from 3 to 18 months) showing spending, income and asset withdrawal versus planned asset withdrawal. The system can also generate a pop-up box 350b that includes more hyperlinks to other details or items in which the user might have interest.

Referring back to the display 300 in FIG. 3, below the current balance of the retirement income management account, there is a projected number of months (i.e., 2.5) until which the retirement income management account must be refilled. This number is calculated by dividing the user's IMA balance (the spending money on hand) by an average of the user's actual asset withdrawal. The second column 310 also includes a graph 355 showing the monthly balance of the retirement income management account for six months.

Below the graph 355 is another message box 360. The message box 360 includes a projection of number of months of spending money that remain in the retirement income management account. The message box 360 includes a textual summary 360a that states to the user that she has 2.5 months of spending remaining. This is the same calculation described above, presented as the number of months until account has to be refilled. The message box 360 also includes a hyperlink 360b that enables the user to access more details about the remaining months of spending money. FIG. 3G illustrates a pop-up box 360c that the system generates when the user clicks on “More . . . . ” Pop-up box 360c inlcudes a more detailed message is provided that reminds the user that it is recommended to keep at least 6 months of asset withdrawal in the account.

Referring back to the display 300 in FIG. 3, the third column 315 represents a summary of the retirement cash flow, which calculates the difference between funds coming into the retirement income management account and funds leaving the retirement income management account. The third column 315 includes a pull-down menu 365 that enables a user to select a period of time for which the cash flow data is displayed in area 370. The area 370 displays the sources and amounts of retirement income being deposited into the retirement income management account for the period selected by element 365. The area 370 also includes the amount of money that was withdrawn from the retirement income management account (the spending amount) for the period selected by element 365. By subtracting the spending amount from the income amount, the area 370 also includes a gap amount which, if the spending exceeds the income, represents the amount of funds that had to be withdrawn from the user's retirement asset accounts. The third column 315 also includes a hyperlink 375 to enable the user to obtain more detailed information about the transactions. FIG. 3H illustrates a display 375a that the system generates when a user selects the hyperlink 375. With the display 375a, users can view detailed information about individual transactions for inflows and outflows associated with the IMA.

Referring back to the display 300 in FIG. 3, below the hyperlink 375, there is a comparison area 380 that shows a comparison between the actual average monthly withdrawal amount (i.e., the −$2, 929.00) from the retirement asset accounts and the planned withdrawal amount (i.e., the −$2,284.69) from the retirement asset accounts. The user quickly views how her actual performance is doing compared to her plan and how large the discrepancy is. Again, a 12-month average monthly average is used to smooth any single monthly spikes that may be due to quarterly payments, such as tax payments or large single month spending, such as shopping for the grandchildren for a holiday.

Below the comparison area 380 is another message box 385. The message box 385 includes a comparison summary of the withdrawal amount. The comparison summary of the withdrawal amount includes a textual summary 385a that states to the user that the actual amount is within 10% of the planned amount. The textual summary 385a provides the user with a quantitative summary of how her actual withdrawal amount compares to her planned withdrawal amount. The comparison summary of the withdrawal amount also includes a hyperlink 385b that enables the user to access more details about the comparison of the actual withdrawal amount to the planned withdrawal amount.

FIG. 3I illustrates a pop-up box 385c that the system generates when the user selects the hyperlink 385b. This more detailed message in the pop-up box 385c restates that the customer's actual average withdrawal amount over the past 12 months is 22% of the planned first year withdrawal amounts and suggests actions that the user may want to take, depending on the particular situation.

As described above, the display 300 provides a single point that brings the user's retirement plan, the user's retirement asset accounts, and the user's retirement income management account (e.g., a centralized cash flow management account) together. This enables an automated comparison between the user's retirement plan and the user's actual spending and asset allocation. The user can quickly see if she is on track and change her spending behaviors and/or her plan to bring the two within an acceptable level of difference. Also, from the display 300, the user can navigate to more details about the user's retirement plan, the user's retirement asset accounts, and the user's retirement income management account.

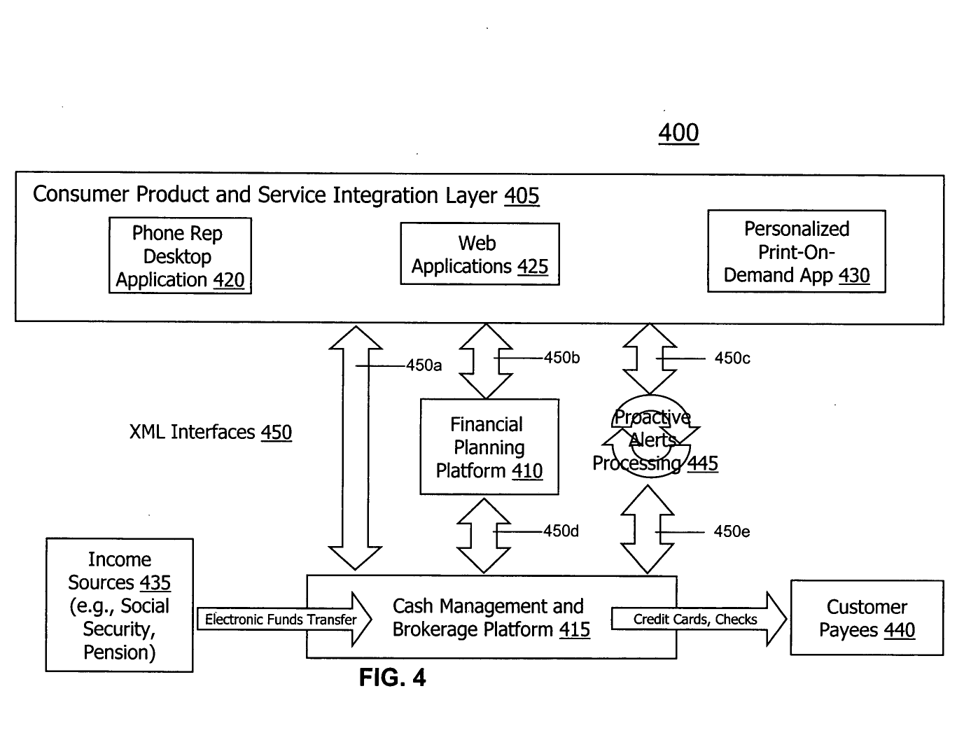

FIG. 4 illustrates an architecture 400 used for combining a retirement income management account with a retirement income plan. The architecture 400 includes a consumer product and service integration layer 405, a financial planning platform 410, and a cash management and brokerage platform 415. The consumer product and service integration layer 405 serves as an interface for a user or a service representative, such as the phone representative. The consumer product and service integration layer 405 enables the user or the service representative to access the financial planning platform 410 to enter and modified a retirement income plan. The consumer product and service integration layer 405 also enables the user or the service representative to access the cash management and brokerage platform 415 to view details of deposit and withdrawal transactions occurring on the user's retirement income management account and the user's retirement asset accounts. The consumer product and service integration layer 405 includes a phone rep desktop application 420, Web applications 425, and personalized print on demand application 430. Generally, the rep desktop application 420 provides the interface that a service representative uses. The Web applications 425 provide the interfaces that the user uses over a network, such as the Internet.

The Web applications 425 can include an application that generates a display, such as display 300, that provides a comparison between a retirement income plan and actual retirement income cash flow. Such an application can obtain data from both the financial planning platform 410 and the cash management and brokerage platform 415. Through the personalized print on demand application 430, the user receives a monthly Income Management Report which provides a monthly snapshot of the same information that is available through the online monitoring application.

The cash management and brokerage platform 415 includes the hardware and software to administer the retirement income management account and the retirement asset account(s) of the user. The cash management and brokerage platform 415 receives deposits from retirement income sources 435. This can be done automatically through electronic fund transfers. The cash management and brokerage platform 415 also transfers funds out (e.g., via credit card use and checks written by the user) to customer payees 440. The cash management and brokerage platform 415 stores these transactions so that they can be used by the other components (e.g., Web applications 425, financial planning platform 410, proactive alerts processing 445, etc.) to monitor transactions and calculate statistics (e.g., average monthly withdrawals).

In the architecture 400, the cash management and brokerage platform 415 communicates data to and from other components (e.g., consumer product and service integration layer 405, financial planning platform 410, proactive alerts processing 445, etc.) using extended markup language (XML) interfaces 450 (e.g., 450a, 450b, 450c, 450d, and 450e). This enables a normalized data exchange between the components of architecture 400 regardless of the data structures used by each of the individual components.

The architecture 400 includes a proactive alerts processing module 445. The alerts module 445 provides (e.g., via the Web applications 425) a user interface to a user so that a user can select one or more alerts for which the user wants to be notified. The alerts module 445 then monitors certain data obtained and transferred from the components of the architecture 400. For example, the alerts module 445 communicates with the consumer product and service integration layer 405 via the XML interface 450c and with the cash management and brokerage platform 415 via the XML interface 450e. When certain conditions are met, the alerts module 445 notifies the user.

FIG. 5A illustrates an example of a display 500 that serves as a user interface for selecting alerts. Display 500 includes ten alerts to which the user can subscribe. The alerts can be associated with user's retirement plan, the user's retirement asset accounts, and the user's retirement income management account. The alerts include confirmations when expected deposits are made. The alerts also include alerts when expected deposits are not made. The alerts include alerts when funds and spending money are running low, or when periodic payments are due. The alerts include alerts when the actual asset allocation or the actual withdrawal amount/rate varies from the planned asset allocation or the planned withdrawal amount/rate by more than some threshold amount (e.g., 15%). The alerts also include alerts when the period of time since the user visited her plan exceeds some threshold amount (e.g., 3 months).

To use the display 500, a user can click on a check box (e.g., check box 505) next to the alert to which the user wants to subscribe. The user can also select the delivery channel through which the user wants the alert delivered. For example, for the “Social Security Deposit Confirmed” alert, the user can select either an email delivery (e.g., by clicking an “E-mail” check box 510 associated with the alert) or a phone delivery (e.g., by clicking a “Phone” check box 515 associated with the alert). If email is the delivery channel, the system sends an automatic email to the user when the condition is met (e.g., the transaction of receiving a deposit from Social Security is stored). If phone is the delivery channel, the system sends an automatic phone message to the user when the condition is met. For example, for the “Social Security Deposit Confirmed” alert, the system automatically dials the user's phone number and, upon the user answering the phone, generates a computer generated text-to-speech message that the Social Security check was deposited. The message can include the date of the deposit, the source of the deposit, and the amount of the deposit.

FIGS. 5B-5D illustrate another example of a display 520 that serves as a user interface for selecting alerts. Display 520 includes eleven alerts to which the user can subscribe. Area 525 shows the channels of delivery available for the alerts. The user can select from multiple channels of delivery including multiple email addresses, a pager, and/or a cell phone. The user interface of display 520 also includes entry elements 530 (e.g., a drop-down menu) to enable the user to enter specific date details needed by the system to determine when to transmit an alert to the user. FIG. 5D includes three alerts that are transmitted periodically, as scheduled by the user. In the user interface of display 520, an entry element 535 (e.g., a drop-down menu) is used to enable the user to enter specific time at which the selected alerts are transmitted on a daily basis.

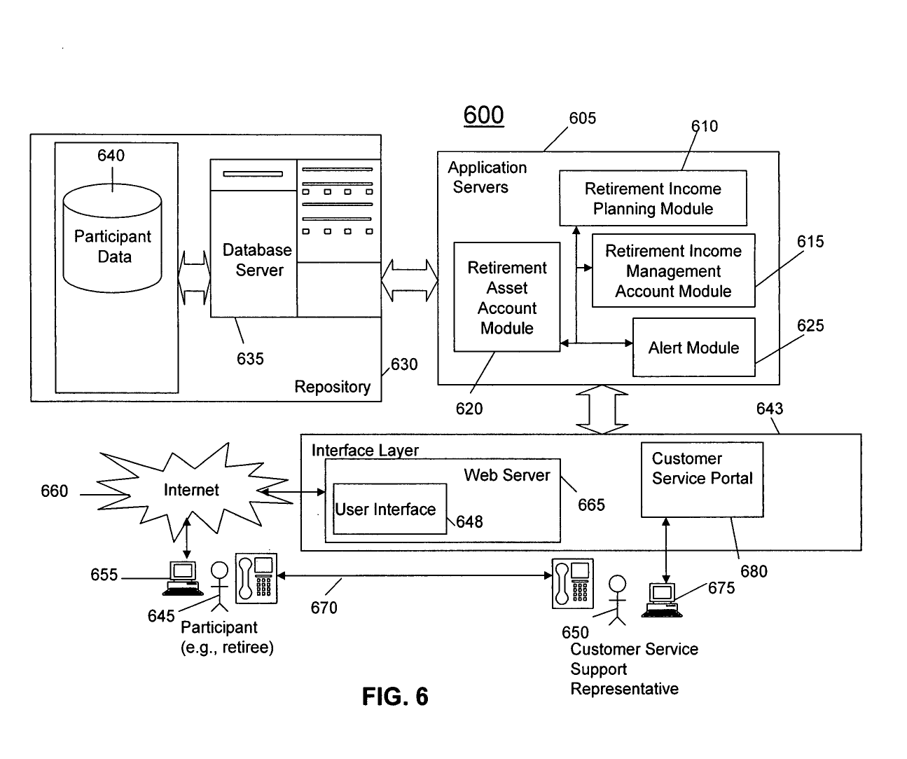

FIG. 6 illustrates an example of a system 600 that can be used for combining a retirement income management account with a retirement income plan. The system 600 includes application servers 605 on which the applications described above (e.g., a retirement income planning module 610, a retirement income management account module 615, a retirement asset account module 620, and an alert module 625) execute. The application servers 605 are in communication with a repository 630. The repository 630 includes a database server 635 that enables access (e.g., using a structured query language (SQL)) to a database 640 that stores the participant data, including values for variables on an individual level as well as the system level.

The system 600 includes an interface layer 643 that enables a participant 645 and a service representative 650 access to the modules executing on the application servers 605. The participant 645 uses a personal computer 655 to access a communications network 660 (e.g., the Internet). The network 660 provides a communication path to a Web server 645 that services requests received from the network 640. The Web server 645 can generate a user interface 648 (e.g., a HTML Web page) that enables the user to communicate with the Web server 665 using a Web browser application in the computer 655. As described above, a provided Web page (e.g., displays 300 and 500) can contain information (e.g., comparisons between retirement plans and actual retirement accounts) and include interactive elements so that the participant can navigate through the retirement plans and accounts administered by the service provider.

The service provider can also provide a customer service support representative 650 that can assist the participant in accessing any of the modules (e.g., 610, 615, 620, 625). The participant 645 can call the customer service support representative 650 using a telephone line 670. The customer service support representative 650 can access the retirement modules using his computer 675 and a customer service portal 680.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A computerized method for combining a retirement income management account with a retirement income plan, the method comprising:
obtaining a first set of data from a retirement income plan associated with a user, the first set of data including a projected withdrawal from a retirement asset account;
obtaining a second set of data from a retirement income management account associated with the user;
determining an actual withdrawal from the retirement asset account based on the second set of data; and
generating a display showing the projected withdrawal compared to the actual withdrawal.

2. The method of claim 1, further comprising:
calculating a variance between the actual withdrawal and the projected withdrawal; and
generating the display showing the variance.

3. The method of claim 2, wherein the variance is displayed as a percentage.

4. The method of claim 1, wherein the projected withdrawal and the actual withdrawal are represented as percentages.

5. The method of claim 1, wherein the projected withdrawal and the actual withdrawal are represented as dollar amounts.

6. The method of claim 1, wherein the projected withdrawal and the actual withdrawal are represented over a period of one month.

7. The method of claim 6, wherein the projected withdrawal and the actual withdrawal are represented using an average over twelve months.

8. The method of claim 1, wherein the first set of data includes a target asset allocation for the retirement asset account and the second set of data includes an actual asset allocation for the retirement asset account, the method further comprising:
calculating a variance between the actual asset allocation and the target asset allocation; and
generating the display showing the variance.

9. The method of claim 8, further comprising:
including a hyperlink associated with the variance; and
enabling the user to navigate to the retirement asset account using the hyperlink.

10. The method of claim 8, further comprising transmitting an electronic alert message when the variance exceeds a predefined threshold.

11. The method of claim 1, further comprising providing a user interface enabling the user to access the retirement income plan and the retirement income management account.

12. The method of claim 11, further comprising transmitting an electronic alert message when the user has not accessed the retirement income plan for a period greater than a predefined threshold.

13. The method of claim 1, further comprising transmitting an alert message to the user when a predetermined condition is met.

14. The method of claim 1, further comprising providing a user interface enabling a user to select one or more alert messages.

15. The method of claim 14, wherein the one or more alert messages comprise a social security deposit confirmed message, a social security deposit not received message, a pension deposit confirmed message, an annuity deposit confirmed message, a spending money low message, an insufficient funds for transfer message, an estimated quarterly tax payment due message, a minimum required distribution (MRD) deadline upcoming message, a current asset allocation off target message or a plan not visited recently message.

16. The method of claim 14, wherein the user interface enables the user to select a channel of delivery for at least one alert message.

17. The method of claim 16, wherein the channel of delivery comprises an electronic message or a phone.

18. The method of claim 1, further comprising updating the retirement income plan based on the second set of data.

19. The method of claim 1, further comprising calculating a projected period of time remaining until the retirement asset account is depleted based on the second set of data.

20. The method of claim 1, wherein the retirement asset account includes a 401K account.

21. The method of claim 1, wherein the retirement asset account includes an individual retirement account (IRA) account.

22. The method of claim 1, wherein the retirement asset account includes a portion of funds being held as equities.

23. The method of claim 1, further comprising representing the first set of data using XML.

24. A computerized method for combining a retirement income management account with a retirement income plan, the method comprising:
obtaining a first set of data, represented using XML, from a retirement income plan associated with a user, the first set of data including a projected withdrawal from a retirement asset account;
obtaining a second set of data from a retirement income management account associated with the user;
determining an actual withdrawal from the retirement asset account based on the second set of data;
determining whether a predefined alert condition has been met using the first set of data or the second set of data; and
generating a display showing the projected withdrawal compared to the actual withdrawal.

25. A computer program product, tangibly embodied in an information carrier, for combining a retirement income management account with a retirement income plan, the computer program product including instructions being operable to cause data processing apparatus to:
obtain a first set of data from a retirement income plan associated with a user, the first set of data including a projected withdrawal from a retirement asset account;
obtain a second set of data from a retirement income management account associated with the user;
determine an actual withdrawal from the retirement asset account based on the second set of data; and
generate a display showing the projected withdrawal compared to the actual withdrawal.

26. A system for combining a retirement income management account with a retirement income plan, the system comprising:
a financial planning platform to enable a user to create a retirement income plan;
a cash management and brokerage platform to enable the user to manage retirement income and retirement asset accounts, the cash management and brokerage platform being in communication with the financial planning platform using an XML interface; and
a consumer interface layer to enable the user to access the retirement income plan and the retirement income and retirement asset accounts, the consumer interface layer being in communication with the financial planning platform and the cash management and brokerage platform.

27. A system for combining a retirement income management account with a retirement income plan, the system comprising:
a first means for obtaining from a retirement income plan a projected withdrawal from a retirement asset account;
a second means for obtaining from a retirement income management account an actual withdrawal from the retirement asset account; and
a third means for generating a display showing the projected withdrawal compared to the actual withdrawal.
